(19) United States
(12) Patent Application Publication
(10) Pub. No.: US 2006/0260509 A1
(43) Pub. Date: Nov. 23, 2006

(54) Compositions for enhanced paper brightness and whiteness

(76) Inventor: Glenn R. Evers, Hockessin, DE (US)

Correspondence Address: RATNERPRESTIA, P.O. BOX 1596, WILMINGTON, DE, 19899, US

(21) Appl. No.: 11/408,331

(22) Filed: Apr. 21, 2006

Related U.S. Application Data
(60) Provisional application No. 60/673,873, filed on Apr. 22, 2005.

(51) Int. Cl. C08L 95/00

(52) U.S. Cl. 106/234; 8/648

(57) ABSTRACT

A composition comprising an fluorescent whitening agent and a micropolymer is useful for making paper, or for applying to an already-formed paper surface. The composition may further include an inorganic filler, such as alumina trihydrate, and may also include a pigment, such as titanium dioxide.

### CROSS REFERENCE TO RELATED APPLICATIONS

This application claims priority of U.S. Provisional Application No. 60/673,873, filed Apr. 22, 2005, the entire disclosure of which is incorporated herein by reference.

### BACKGROUND OF THE INVENTION

It has long been desired to produce paper products, particularly those which will be printed upon, that have high opacity so that images or text from one side of the paper do not show through to the other side, thereby diminishing graphic quality. At the same time, it has also been long desired that paper intended for printing purposes be white, and even bright, since this is often perceived as enhancing image quality. However, methods and compositions capable of providing having high opacity sometimes provide only mediocre whiteness and/or brightness, and vice versa. Therefore, ways of providing paper with high levels of both opacity and whiteness/brightness are much desired.

### SUMMARY OF THE INVENTION

In one aspect, the invention provides a composition comprising an fluorescent whitening agent and a micropolymer.

In another aspect, the invention provides, in a paper coating, the improvement comprising including in the coating a composition comprising an fluorescent whitening agent and a micropolymer.

In yet another aspect, the invention provides a method of treating paper, the method comprising applying to the paper a composition comprising an fluorescent whitening agent and a micropolymer.

In still another aspect, the invention provides a method of making paper, the method comprising adding to a pulp slurry a composition comprising an fluorescent whitening agent and a micropolymer.

### BRIEF DESCRIPTION OF THE DRAWINGS

FIG. 1 shows fluorescent whitening agent performance in the presence of a micropolymer according to the invention, compared with fluorescent whitening agent without micropolymer.

FIG. 2 shows fluorescent whitening agent performance in the presence of a micropolymer according to the invention, measured on the coated and uncoated sides of treated paper.

FIG. 3 shows fluorescent whitening agent performance without the presence of a micropolymer, measured on the coated and uncoated sides of treated paper.

FIG. 4 shows fluorescence of papers coated with alumina trihydrate in combination with fluorescent whitening agent and micropolymer according to the invention, compared with alumina trihydrate combined with only micropolymer or combined with only fluorescent whitening agent.

### DETAILED DESCRIPTION OF THE INVENTION

Compositions Containing Micropolymer and Fluorescent Whitening Agent

The invention provides compositions comprising a micropolymer and an fluorescent whitening agent. Micropolymers suitable for use according to the invention include any anionic microparticulate or similar anionic organic polymer used in the papermaking industry as a drainage/retention/formation aid, and will be discussed in detail later herein. Compositions according to the invention may have relative amounts of micropolymer and fluorescent whitening agent in any proportion. Exemplary formulations may fall within the ranges shown in the following table, where the amounts shown indicate, in percent by weight, the amount that each ingredient contributes to the total of all listed ingredients.

| | | More | Most | | More | Most |
|---|---|---|---|---|---|---|
| | Typical | Typical | Typical | Typical | Typical | Typical |
| | Lower | Lower | Lower | Upper | Upper | Upper |
| | Amount | Amount | Amount | Amount | Amount | Amount |
| Fluorescent | 98 | 99 | 99.8 | 1 | 50 | 92 |
| Whitening | | | | | | |
| Agent | | | | | | |
| Micropolymer | 2.0 | 1.0 | 0.2 | 99 | 50 | 8 |

Compositions Containing Micropolymer, Fluorescent Whitening Agent, and Filler

The invention provides compositions comprising a micropolymer an fluorescent whitening agent, and filler. In some embodiments, the filler is alumina trihydrate (ATH). Formulations for such compositions may have relative amounts of these ingredients in any proportion. Exemplary formulations may fall within the ranges shown in the following table, where the amounts shown indicate, in percent by weight, the amount that each ingredient contributes to the total of all listed ingredients.

| | | More | Most | | More | Most |
|---|---|---|---|---|---|---|
| | Typical | Typical | Typical | Typical | Typical | Typical |
| | Lower | Lower | Lower | Upper | Upper | Upper |
| | Amount | Amount | Amount | Amount | Amount | Amount |
| Fluorescent | 0.1 | 1 | 1.5 | 7 | 3.0 | 1.5 |
| Whitening | | | | | | |
| Agent | | | | | | |
| Micropolymer | 0.001 | 0.01 | 0.01 | 2.0 | 1.0 | 0.1 |
| Filler | 100 | 100 | 100 | 100 | 100 | 100 |

In some embodiments, the fluorescent whitening agent and the micropolymer together constitute at least 10 wt % of all nonvolatile organic components in the composition. In some embodiments, the fluorescent whitening agent and the micropolymer together comprise at least 0.01 wt % of the composition.

Compositions Containing Micropolymer, Fluorescent Whitening Agent, Filler, and Titanium Dioxide

The invention provides compositions comprising a micropolymer an fluorescent whitening agent, filler, and titanium dioxide. Formulations for such compositions may have relative amounts of these ingredients in any proportion. Exemplary formulations may fall within the ranges shown in the following table, where the amounts shown indicate, in percent by weight, the amount that each ingredient contributes to the total of all listed ingredients.

| | | More | Most | | More | Most |
|---|---|---|---|---|---|---|
| | Typical | Typical | Typical | Typical | Typical | Typical |
| | Lower | Lower | Lower | Upper | Upper | Upper |
| | Amount | Amount | Amount | Amount | Amount | Amount |
| Fluorescent | 0.02 | 2 | 2 | 7 | 1 | 0.16 |
| Whitening | | | | | | |
| Agent | | | | | | |
| Micropolymer | 0.01 | 0.01 | 0.01 | 0.5 | 0.25 | 0.1 |
| Filler | 1 | 4 | 8 | 50 | 12 | 8 |
| Titanium | 100 | 100 | 100 | 100 | 100 | 100 |
| Dioxide | | | | | | |

As used herein, the term “bound” as applied to components in the composition means that at least a portion of each of the items being bound is adsorbed, absorbed, covalently bonded, ionically bonded, or otherwise attached either reversibly or irreversibly to the other. Such attachment may be either direct, or through an intervening material, such as one of the other components of the composition. Without intending the scope of the invention to be limited by this explanation, the inventors believe that at least a portion of the fluorescent whitening agent and at least a portion of the micropolymer are bound together in the present compositions, and that the resulting material in turn may be at least partially bound to at least some of the filler and/or at least some of the titanium dioxide, in those compositions that contain them. As used herein, the term “water-soluble” when applied to a polymer includes polymers that can be dissolved or otherwise stably dispersed in water, and it includes such polymers even when bound to a particle of pigment or latex.

Compositions according to the invention may consist essentially of the fluorescent whitening agent and the micropolymer, and optionally filler and optionally titanium dioxide, and may therefore be essentially dry. Such dry compositions may suitably be incorporated into a finished item, such as a web, roll, or sheet of paper, and this is one particularly useful application of the compositions of the invention. Such a use may provide paper of high opacity and/or brightness.

In other embodiments of the invention, the compositions are in the form of an aqueous dispersion, which may be of any concentration. Typically, such dispersions contain between about 1 wt % and 25 wt % total combined mass of fluorescent whitening agent, micropolymer, optionally filler, and optionally TiO₂, and more typically between about 4 wt % and 12 wt % (dry weight on dry TiO₂ basis). Such compositions may be particularly suitable for use in compositions for coating paper. In some embodiments, the fluorescent whitening agent and micropolymer together constitute at least 20 wt %, typically at least 50 wt %, and more typically at least 90 wt % of the total combined nonvolatile organic components in the composition. As used herein, the term “nonvolatile organic component” means an organic material, other than a mineral oil or fatty oil, that either cannot boil or that boils at a temperature above 150° C. One example of a nonvolatile organic component is cellulose, such as pulp fiber.

It has been found that the compositions of this invention, despite containing a high molecular weight polymer (the micropolymer), generally have viscosities low enough to provide easy handling. This is somewhat surprising, since it would be expected that similar formulations using linear high molecular weight polymers (typical anionic polyacrylamides, for example) would give very high viscosities. Surprisingly, these micropolymer flocculants do not increase the viscosity of the TiO₂ slurry nor does the micropolymer impair the high solids slurry grinding of TiO₂ in water. The resultant slurry has a relatively low viscosity, both before and after dilution. Pumpable slurries having a TiO₂ content of greater than 40 wt %, 50 wt %, or even greater than 65 wt % can typically be achieved.

After dilution, the slurry has low viscosity and good anti-settling properties versus the control. It is hypothesized that the polymeric micropolymer/ATH bonds to TiO₂ to reduce settling, due to the ATH's low density relative to the TiO₂. I.e., the composite particles have an overall density much less than that of TiO₂, and therefore settle less quickly.

The micropolymer/ATH/TiO₂ composite has the advantage of more uniformly retaining in the paper when added to the wet end. Prior art “ATH/TiO₂ mixtures” such as those disclosed in US 2004/0107871 lack a bonding agent between particles and to the pulp fiber to improve retention. During commercial paper making, TiO₂/ATH mixtures are added in the wet-end with the intention of incorporating these white pigments in the base sheet to improve whiteness and opacity. Large ATH particles are preferentially retained in the sheet whereas a disproportionate number of smaller dispersed TiO₂ particles exit the paper as water is extracted out of the paper during sheet formation. Preferential retention of large ATH particles relative to the TiO₂ added results in a non-uniform distribution of filler in the base sheet even with subsequent recycling of the white water. For example, ATH particles (1 um particle size) blended with rutile TiO₂ (0.25 um particle size) as a 25/75 weight percent blend, respectively, provide on a first pass basis a 50/50 ATH/TiO₂ weight percent ratio in the base sheet due to preferential first pass retention of the larger particle ATH. The present invention thus also addresses the problem of enriching one filler versus another in the paper sheet. It is believed that this is accomplished by the ATH particles being bound to TiO₂ prior to their introduction into the paper makers wet-end.

In still other embodiments, the composition is highly diluted with water and further comprises pulp fibers to which the fluorescent whitening agent and micropolymer, and optionally filler and titanium dioxide, are bound. In one typical use, such a composition is found in the thick stock and/or the thin stock of a papermachine, during the process of making paper. Optionally, in such applications, cationic polymers of any of a variety of types may be incorporated in the papermaking operation to enhance retention of the composition in the paper. Examples of useful polymers include polydiallyldimethylammonium chlorides such as Reten® 203 (available from Hercules Incorporated of Wilmington, Del.) and cationic polyacrylamides, many of which are known in the water-soluble polymer art. Also suitable are polyethylenimines, some of whose amine groups are protonated at pH values less than 7 and which therefore are cationic under these conditions.

Fluorescent Whitening Agent

Fluorescent whitening agents (FWA), also known as optical brightening agents (OBA) enhance the light reflectance qualities, thus improving the whiteness and brightness of the coated sheet. Optical brightening agents suitable for use according to the invention include, as nonlimiting examples, sulfonated stilbene-based compounds such as are well known in the art. The FWA may be any chemical with the fluorescent ability to take in light from the ultraviolet part of the light spectrum and emit it in the visible spectrum. Typically the fluorescent whiteners are stilbene fluorescent whitening agents, such as described in GB-A-2026566 and GB-A-2026054 or bis-stilbene fluorescent whitening agents, as described in EP-A-624687. Suitable fluorescent whitening agents include diaminostilbene disulphonic acid derivatives and distyryl biphenyl derivatives. Particularly useful fluorescent whitening agents for use in coatings are diamino stilbene hexasulfonic acid (TINOPAL SPP available from Ciba Specialty Chemicals) and diamino stilbene tetrasulfonic acid (TINOPAL ABP-A available from Ciba Specialty Chemicals).

More preferred for this invention, especially as applied to papermaking wet-end and coating operations, is TINOPAL ABP-A diamino stilbene tetrasulfonic acid, available from Ciba Specialty Chemicals as 90% Strength, 22% active solids (AS) ingredient. It is FDA approved as a “Brightener 220”, a main concern for coated board. Typically, the fluorescent whitening agents are provided in the form of an aqueous concentrated slurry, usually at least 22-30% by weight, for instance about 60% by weight. Suitable FWA's are disclosed in U.S. Pat. No. 6,736,936.

These optical brighteners are in a general and not limiting manner of the type that include in their molecule the stilbene component substituted by diamines and sulfonic groups. These brighteners convert part of the invisible UV radiation into visible light, generally in the blue to violet range.

A nonlimiting example of a suitable stilbene disulfonic acid derivatives used as optical brightener is the product “TINOPALTM SK”, a distearyl biphenyl OBA, marketed by the Ciba Company.

Another nonlimiting example of a suitable optical brightener is the product TINOPAL PT (Ciba Specialty Chemicals), a stilbene tetrasulfonated conventional “A” “100% strength” derivative, Na salt of 4,4′-diamino-2,2′stilbene; urea stabilized, (also called Triazinyl Stilbene)

Another nonlimiting example of a suitable optical brightener is the product Blankophor™ (P or BPN)” marketed by the Lanxess Company (previously, Bayer Company). FWA concentrations are typically used in the range of 0.1-1.0% in wet end addition for dry food packaging boards.

Micropolymers and composites of this invention may also be premixed with colorants such as IRGALITE™ Violet RM and IRGALITE™ Blue FP (available from Ciba Specialty Chemicals). These micropolymer blends can be used either alone or in combination with each other for wet end or in coating application.

Micropolymers

Micropolymers suitable for use according to the invention include any anionic microparticulate or similar anionic organic polymer used in the papermaking industry as a drainage/retention/formation aid. Exemplary micropolymers include charged organic polymer microbeads, such as those disclosed in U.S. Pat. Nos. 5,167,766 and 5,274,055 to Honig et al., the entire disclosures of both of which are expressly incorporated herein by reference. Also suitable are Hydrophobically Associative Polymers such as are described for use as drainage and retention aids in U.S. Pat. No. 6,417,268 to Zhang et al., the entire disclosure of which is expressly incorporated herein by reference.

Other suitable micropolymers include anionic polymers in which the Huggins' constant (k′) as determined in 0.01M NaCl is greater than 0.75 and the storage modulus (G′) for a 1.5 wt. % actives polymer solution at 4.6 Hz is greater than 175 Pa. Such polymers are described in U.S. Pub. No. 2004/0102528 A1 to Walchuk et al., the entire disclosure of which is expressly incorporated herein by reference. These anionic copolymers have the preferred formula: [symbol]
B-co-F [symbol] (Formula I)
wherein B is a nonionic polymer segment formed from the polymerization of one or more nonionic monomers; F is an anionic polymer segment formed from polymerization of one or more ethylenically unsaturated anionic monomers; the molar % ratio B:F is from 5:95 to 95:5; and “co” is a designation for a polymer system with an unspecified arrangement of two or more monomer components. Furthermore, the preparation is conducted in a fashion, absent cross-linking agents and via a water-in-oil emulsion procedure, such that the Huggins' constant (k′) determined in 0.01M NaCl is greater than 0.75 and the storage modulus (G′) for a 1.5 wt. % actives polymer solution at 4.6 Hz is greater than 175 Pa.

The nonionic polymer segment B in Formula I is the repeat unit formed after polymerization of one or more nonionic monomers. Exemplary monomers encompassed by B include, but are not limited to, acrylamide; methacrylamide; N-alkylacrylamides, such as N-methylacrylamide; N,N-dialkylacrylamide, such as N,N-dimethylacrylamide; methyl acrylate; methyl methacrylate; acrylonitrile; N-vinyl methylacetamide; N-vinyl methyl formamide; vinyl acetate; N-vinyl pyrrolidone, alkyl acrylates, alkyl methacrylates, alkyl acrylamides, alkyl methacrylamides, and alkoxylated acrylates and methacrylates such as alkyl polyethylene glycol acrylates, alkyl polyethylene glycol methacrylates mixtures of any of the foregoing and the like.

The anionic polymer segment F in Formula I is the repeat unit formed after polymerization of one or more anionic monomers. Exemplary monomers encompassed by F include, but are not limited to, the free acids and salts of acrylic acid; methacrylic acid; maleic acid; itaconic acid; acrylamidoglycolic acid; 2-acrylamido-2-methyl-1-propanesulfonic acid; 3-allyloxy-2-hydroxy-1-propanesulfonic acid; styrenesulfonic acid; vinylsulfonic acid; vinylphosphonic acid; 2-acrylamido-2-methylpropane phosphonic acid; mixtures of any of the foregoing and the like.

The molar percentage of B:F of nonionic monomer to anionic monomer may fall within the range of 95:5 to 5:95, preferably the range is from about 75:25 to about 25:75 and even more preferably the range is from about 65:35 to about 35:65 and most preferably from about 60:40 to about 40:60. In this regard, the molar percentages of B and F must add up to 100%. It is to be understood that more than one kind of nonionic monomer may be present in the material of Formula I. It is also to be understood that more than one kind of anionic monomer may be present in the material of Formula I.

In some embodiments of the invention, the water-soluble anionic copolymer is defined by Formula I where B, the nonionic polymer segment, is the repeat unit formed after polymerization of acrylamide; and F, the anionic polymer segment, is the repeat unit formed after polymerization of a salt of acrylic acid. This embodiment can be represented by the following formula: 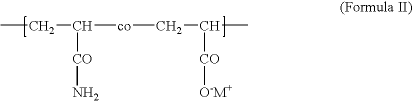
wherein M⁺ is the cation of the salt of the acrylic acid and is typically Na⁺, K⁺ or NH₄⁺; and the molar % ratio of B:F is from about 75:25 to about 25:75.

In other embodiments, in Formula II M is Na and the molar % ratio of the anionic segment to nonionic segment is from 60:40 to 40:60.

The copolymers of Formulas I and II exhibit unique physical characteristics and provide unanticipated activity. The resulting water-soluble anionic copolymer may not be a cross-linked polymer, since no cross-linking agent is utilized in the preparation. However, it is thought that small amounts of cross linking agent should not significantly affect the polymer properties of the micropolymer for purposes of this invention. The physical characteristics of the water-soluble anionic copolymers are unique in that their Huggins' constant (k′) as determined in 0.01M NaCl is greater than 0.75 and the storage modulus (G′) for a 1.5 wt. % actives polymer solution at 4.6 Hz is greater than 175 Pa, typically greater than 190 and more typically greater than 205. The Huggins' constant is greater than 0.75, typically greater than 0.9 and more typically greater than 1.0

The water-soluble anionic copolymers of Formulas I and II may be prepared by an inverse (water-in-oil) emulsion polymerization technique. Preparation of an aqueous solution from the emulsion polymer may be effected by inversion by adding the emulsion polymer to water, wherein the emulsion or water may also contain a breaker surfactant. Breaker surfactants are additional surfactants that are added to an emulsion to promote inversion. The resulting copolymers may also be further isolated by precipitating in an organic solvent such as acetone and dried to a powder form. The powder can be easily dissolved in an aqueous medium for use in desired applications.

In general, an inverse emulsion polymerization process is conducted by 1) preparing an aqueous solution of the monomers, 2) adding the aqueous solution to a hydrocarbon liquid containing appropriate surfactant or surfactant mixture to form an inverse monomer emulsion, 3) subjecting the monomer emulsion to free radical polymerization, and 4) optionally adding a breaker surfactant to enhance the inversion of the emulsion when added to water.

Polymerization of the emulsion may be carried out in any manner known to those skilled in the art. Initiation may be effected with a variety of thermal and redox free-radical initiators including azo compounds such as azobisisobutyronitrile and the like. Polymerization may also be effected by photochemical irradiation processes, irradiation or by ionizing radiation with a ⁶⁰Co source.

Preferred initiators are oil soluble thermal initiators. Typical examples include, but are not limited to, 2,2′-azobis-(2,4-dimethylpentanonitrile); 2,2′-azobisisobutyronitrile (AIBN); 2,2′-azobis-(2,-methylbutanonitrile); 1,1′-azobis-(cyclohexanecarbonitrile); benzoyl peroxide and lauryl peroxide

Any of the chain transfer agents known to those skilled in the art may be used to control the molecular weight. Those include, but are not limited to, lower alkyl alcohols such as isopropanol, amines, mercaptans such as mercaptoethanol, phosphites, thioacids, allyl alcohol, and the like.

The aqueous solution typically comprises an aqueous mixture of nonionic monomer or mixtures of nonionic monomers, and an anionic monomer or mixtures of anionic monomers. The aqueous phase may also comprise such conventional additives as are desired. For example, the mixture may contain chelating agents, pH adjusters, initiators, chain transfer agents as described above, and other conventional additives. For the preparation of the water-soluble anionic copolymer materials the pH of the aqueous solution is below 7 and is typically equal to or greater than 2, more typically the pH is about 4 to about 6.

The hydrocarbon liquid typically comprises straight-chain hydrocarbons, branched-chain hydrocarbons, saturated cyclic hydrocarbons, aromatic hydrocarbons, or mixtures thereof.

The surfactants or surfactant mixtures used in preparing the copolymers of Formulas I and II are generally oil soluble. One or more surfactant can be used. The surfactant or surfactant mixture chosen for making these copolymers includes at least one diblock or triblock surfactant. The choice and amount of the surfactant or surfactant mixtures are selected in order to yield an inverse monomer emulsion for polymerization. Such surfactants are known to those skilled in the art, for example see “Hypermer Polymeric Surfactants: Emulsifiers for Inverse Polymerization Processes”, ICI Surfactants product literature, ICI Americas Inc., 1997. Exemplary surfactants include, but are not limited to, sorbitan monooleate (e.g., Atlas G-946, Uniqema, New Castle, Del.), sorbitan sesquioleate, sorbitan trioleate, polyoxyethylene sorbitan monooleate, di-2-ethylhexylsulfosuccinate, oleamido-propyldimethylamine, sodium isostearyl-2-lactate. Diblock and triblock polymeric surfactants are typically used to make the copolymers. Exemplary diblock and triblock polymeric surfactants include, but are not limited to diblock and triblock copolymers based on polyester derivatives of fatty acids and poly[ethylene oxide] (e.g., Hypermer® B246SF and IL-2595, Uniqema), diblock and triblock copolymers based on poly[ethylene oxide] and poly[propylene oxide], diblock and triblock copolymers based on polyisobutylene succinic anhydride and poly[ethylene oxide], mixtures of any of the foregoing and the like. Typically the diblock and triblock copolymers are based on polyester derivatives of fatty acids and poly[ethylene oxide]. When a triblock surfactant is used, it is preferable that the triblock contains two hydrophobic regions and one hydrophilic region i.e. hydrophobe-hydrophile-hydrophobe. Typically, one or more surfactants are selected in order to obtain a HLB (Hydrophobic Lipophilic Balance) value ranging from about 2 to 8, typically 3 to 7 and more typically about 4 to 6.

The amount (based on weight percent) of diblock or triblock surfactant is dependent on the amount of monomer used. The ratio of diblock or triblock surfactant to monomer is at least about 3 to 100. The amount of diblock or triblock surfactant to monomer can be greater than 3 to 100 and typically is at least about 4 to 100 and more typically 5 to 100 and even more typically about 6 to 100. The diblock or triblock surfactant is the primary surfactant of the emulsification system. A secondary surfactant can be added the ease handling and processing to improve emulsion stability or alter viscosity. Examples of secondary surfactants included but are not limited to sorbitan fatty acid esters, ethoxylated sorbitan fatty acid esters, polyethoxylated sorbitan fatty acid, the ethylene oxide and/or propylene oxide adducts of alkylphenols, the ethylene oxide and/or propylene oxide adducts of long chain alcohols or fatty acids, mixed ethylene oxide/propylene oxide block copolymers, alkanolamides, and the like.

Polymerization of the inverse emulsion may be carried out in any manner known to those skilled in the art, for example see Allcock and Lampe, Contemporary Polymer Chemistry, (Englewood Cliffs, N.J., PRENTICE-HALL, 1981), chapters 3-5.

One specific nonlimiting example of a suitable micropolymer is PERFORM® SP9232 drainage/retention aid, available from Hercules Incorporated of Wilmington, Del. Without wishing to be bound by any particular theory or explanation, this product is thought to have the form of a structured organic particulate, and more particularly is thought to be a water soluble, anionically charged three-dimensional micro-complex. Any material satisfying this general description is also suitable for use according to the invention.

Filler

Especially suitable classes of inorganic fillers for use in the present compositions are selected from the group of metal oxides, aluminum oxide, silicon dioxide, magnesium oxide; hydrates such as aluminum hydrate, alumina trihydrate, colloidal aluminas, colloidal silica, silica gels, phosphates such as aluminum phosphate, metal sulfates such as cerium and calcium sulfate, cadmium sulfide, cadmium sulfoselenides, zinc ferrite, bismuth vanadate and mixed metal oxides, in particular aluminosilicates or calcium aluminosilicates.

Suitable inorganic fillers include inorganic oxides (e.g., zinc oxide), hydrates, sulfates, carbonates that have limited or no solubility in water under the conditions of use. Most typically, the filler is an alumina trihydrate (ATH) or a boehmite filler. Highly suitable ATH fillers are commercially available, for example, various Space-Rite® or Hy-Brite® types sold by Almatis (formerly Alcoa).

Exemplary processes by which these ATH fillers are obtained are described in U.S. Pat. No. 5,171,631 to Adkins, the entire disclosure of which is incorporated herein by reference.

In general the particulate filler is alumina trihydrate filler consisting essentially of particles having an average particle size below 50 um, in particular in the range of from 0.1 to 10 um; especially from 0.2 to 1 um; most typically in the range of from 0.25 to 0.5 um. The desired alumina trihydrate particulate material has a relatively narrow size distribution such that 90% by number have a size below 10 um, typically 90% by number have a size between 0.2 and 1 um. The alumina trihydrate particles can have any shape, typically they are composed primarily of particles having a spherical shape or low aspect ratio.

Advantageously, the alumina trihydrate exhibits little or no absorption of ultraviolet (UV) light, which is instead absorbed by a Fluorescent Whitening Agent (FWA) for conversion to a green-to-blue fluorescent light emission. It is preferably of low color, i.e., of high whiteness.

The filler particle may also have a porous surface. The porosity can be created by randomly flocculating the several filler particles to form pores or the pores can be created by lamellar arrangements due to filler particles stacked one on top of each other. In general, the expression “porous surface” means that there are numerous holes or pores in the surface of the filler particle and a porous network within the particle confines. In general, the pores mainly have a size in the range of from 0.05 to 0.6 um; alternatively in the range from 0.05 to 0.4 um or in the range from 0.1 to 0.4 um.

The pore size is easily measured by mercury porosimetry, BET nitrogen adsorption, and/or scanning electron microscopy. Typically, a scanning electron micrograph shows only surface pores.

Preferably, the specific surface area of the ATH particulate material according to this invention is above 0.1 m²/g. Most preferably, the specific surface area is above 1 m²/g, especially in the range from 2 to 12 m²/g.

Alumina trihydrate (ATH) suitable for use according to the invention includes any commercially available material. Particularly suitable ATH includes a product sold by Almatis under the name SPACERITE S11, having a particle size of about 0.2 μm. Exemplary ATH particles, including particularly useful dispersants for the particles, are described in U.S. Pat. No. 5,171,631 to Adkins, and in U.S. Pub. No. 2004/0107871 A1 to Defeo et al., the entire disclosures of both of which are expressly incorporated herein by reference.

TiO₂ suitable for use according to the invention may be any anatase or rutile TiO₂ known in the art for use as a pigment, and includes for example material produced by a chloride process or a sulfate process, such as are commonly practiced in the art. It may also include zirconia-coated, magnesia-coated, alumina-coated and/or silica-coated TiO₂, such as is known in the art, or any other surface-modified TiO₂ such as organic silane, siloxane and polyphosphonate treatments. Aminosilane surface treatment of TiO₂ may optionally be used to impart a cationic charge on the dry pigment before it is incorporated into a composition according to the invention. Preferably, the TiO₂ will be of pigment grade, and preferably it is slightly acidic and preferably has a pH greater than the isoelectric point of the pigment, although these are not required. The pH of the titanium dioxide may be adjusted to a desired value by any means known in the art, including for example treatment with compounds such as ammonium phosphate, triethanolamine, or aminomethylpropanol.

TiO₂ having an average particle size of at least 0.25 um and less than 1 um is suitable, and more typically the average particle size is between 0.25 and 0.4 um. Especially preferred is TiO₂ that is pre-ground by an air or steam fluid energy mill to pigmentary size. Also suitable is TiO₂ where the particles have been reduced in size by a wet grinding method, for example as disclosed in U.S. Pat. No. 5,270,076, to break up and disperse aggregates and agglomerates of TiO₂. If a wet grinding method is used, the TiO₂ should preferably be present in aqueous media at a loading level of about 35-50%, preferably 35-45% by weight, based on the combined weight of aqueous media and the TiO₂.

The applicants have found that, in particular, the use of anatase TiO₂ may provide a product with very good brightness and whiteness. Combinations of anatase and rutile may provide both a high level of whiteness and brightness, and good opacity. Without wishing to be bound by any particular theory or explanation, it is believed that rutile contributes a high “L” value, as measured by the Hunter Lab method, and thus contributes to high opacity, while the anatase contributes a low “b” value, thus enhancing the blue component of scattered light. The blue component is emphasized in many brightness measurement methods, and thus anatase is believed to enhance the brightness of paper or other products containing the compositions of this invention. The effect of anatase on brightness is often especially strong when the composition also contains an fluorescent whitening agent. It is believed that, since fluorescent whitening agents operate by converting ultraviolet light to visible blue light, and since anatase has relatively low ultraviolet absorption compared with rutile, fluorescent whitening agents may work to better effect when at least some rutile is replaced by anatase.

Preparation of the Compositions

The invention also provides methods of making compositions such as those described above. In general, the method may include the steps of mixing together the fluorescent whitening agent and the micropolymer, and optionally combining that mixture with alumina trihydrate. Typically, the alumina trihydrate particles are added slowly with strong agitation to at least a portion of the combined fluorescent whitening agent and micropolymer, in an aqueous mixture. In some embodiments, a suitable acid such as citric acid is added, either all before the alumina trihydrate is added or incrementally along with it, so as to obtain a desired pH in the resulting dispersion and to reducing the tendency of the ATH to form a “hard heel” or partially solidified mass. Typically, a pH between 6.0 and 8.0 is desired, more typically between 6.7 and 7.3, but other values may be acceptable. If titanium dioxide is also included in the formulation, it is typically added after the pH of the mixture has been so adjusted, but it may be added at any time before or after mixing the fluorescent whitening agent and the micropolymer.

Use of the Compositions

Compositions according to the invention may find use in coatings, for example for use on paper. Additionally, the compositions may find use as internal addition additives in papermaking operations, in which the compositions are added to a pulp slurry in the wet end of the papermachine.

In one exemplary embodiment, the papermaking process of the present invention uses 0.003 lb of micropolymer per ton of pulp. Typical micropolymer concentration based on ATH is 0.01%, so the final concentration in the pulp is expected to be 0.00026 lb structured micropolymer/ton of pulp up to 0.003 lb structured micropolymer per ton of dry cellulosic pulp.

### EXAMPLES

Glossary

A-2600—commercial anatase (CPM Industries, Wilmington, Del.)

A-25—commercial anatase (CPM Industries, Wilmington, Del.)

PERFORM SP9232—drainage/retention aid (Hercules Incorporated, Wilmington, Del.)

TINOPAL AB-P—Fluorescent whitening agent (Ciba Specialty Chemicals)

SPACERITE S-11—alumina trihydrate (Almatis Inc., Bauxite, AK)

RPS-VANTAGE™—rutile slurry (DuPont, Wilmington, Del.)

STA-LOK 300A—cationic starch (A E Staley, Decatur, Ill.)

T-4000—anatase slurry (Millennium Chemicals division of Lyondell, Houston, Tex.)

PERCOL 3320—cationic polyacrylamide (Ciba Specialty Chemicals, Basel, Switzerland)

Test Methods

Various test methods were employed to characterize the ATH slurries and ATH/TiO₂ blended slurries of this invention. The pH of the slurries were measured using a Beckman model 200 pH meter and a Corning flat surface combination wRJ electrode. Brookfield viscosity was measured using a standard Brookfield Digital Viscometer, model RTVRD-II, available from Brookfield Engineering Company.

General Process

All slurry and polymer preparations were performed in a 1 liter cylindrical polyethylene vessel. The slurries and polymer preparations of this invention were prepared using a lab scale Emco Model CM-100 Lab Dissolver high-speed disperser, equipped with a 50 mm Cowles blade. All slurry preparations were performed in a cylindrical polyethylene vessel measuring 3 inches in diameter and 6 inches high.

Aqueous Fluorescent Micropolymer Preparation

To a high speed disperser was added deionized water and PERFORM® SP9232. Micropolymer emulsion was made-down to a 1 wt. % concentration with stirring for 30 minutes at low speed (approx. 500-1000 rpm) to achieve adequate dispersion of the polymer. The micropolymer solution was further diluted to 0.1 wt % unless otherwise specified in the examples. Dilute 0.1 wt % micropolymer solution was then mixed with fluorescent whitening agent (FWA), Ciba Geigy TINOPALD ABP in the amounts provided in the tables, corresponding to the examples, with stirring for 30 minutes at low speed (approx. to 500-1000 rpm) to achieve adequate dispersion of the FWA. Additional deionized water was added followed by mixing for 10 minutes at low speed to achieve adequate uniformity.

Fluorescent Alumina trihydrate (ATH) Slurry Preparation

ATH was then added slowly to the aqueous fluorescent polymer solution and mixed at high speed (approx. 2000-3000 rpm) for 15 minutes. A 1.7 wt % citric acid aqueous solution was slowly added and mixed for 10 minutes added for pH adjustment to pH 6.5-7 pH.

Titanium Dioxide Slurry Preparation Incorporating Fluorescent (ATH)

To a high speed disperser was added deionized water and amino-methyl-propanol (AMP). Anatase titanium dioxide was then added slowly and mixed at high speed (approx. 2000-3000 rpm) to dilatant grind the TiO₂ at 83-84% solids for 15 minutes. Fluorescent ATH slurry was then added slowly and mixed at low speed for 15 minutes. Additional deionized water was added followed by mixing for 10 minutes at low speed to achieve adequate uniformity.

### Example 1

### Combination of FWA and Micropolymer

Screening experiments were conducted by mixing small quantities of reagents in a 25 ml polyethylene beaker. The reagents/blends listed in Table 1 were applied to blotting-type paper by drawing down the liquid across the paper surface using a Byrd applicator with a 1 mil (0.0001 inch) gap. (The paper was sufficiently thick so as to provide no interfering slight transmission/absorbance through the base sheet.) The coated paper was allowed to air dry at room temperature for three hours. Amounts of reagents used in Table 1 are in grams.

TABLE 1

| | | Control | Water | Water + | SP9232 | SP9232 + |
|---|---|---|---|---|---|---|
| | Tradename, | DRY(1) | Only(1) | FWA(2) | Only(1) | FWA(3) |
| Reagent | if applicable | 85-0 | 85-1 | 85-2 | 85-3 | 85-4 |
| SP9232 (0.1 wt. %) | PERFORM | — | — | — | 5 | 5 |
| | SP9232 | | | | | |
| FWA | TINOPAL AB-P | — | — | 0.06 | — | 0.06 |
| Deionized Water | | — | 5 | 5 | — | — |
| ATH | SPACERITE S-11 | — | — | — | — | — |

Observations on treated paper
(1) No fluorescence
(2) Water sinks through to opposite side, carrying FWA
(3) FWA stays on top

A can be seen from the results of Table 1, the FWA in paper coated with the composition (85-4) combining a micropolymer (SP9232) and FWA tended to stay on the surface of the paper, whereas the other runs showed either no fluorescence or showed sinking of FWA into the paper.

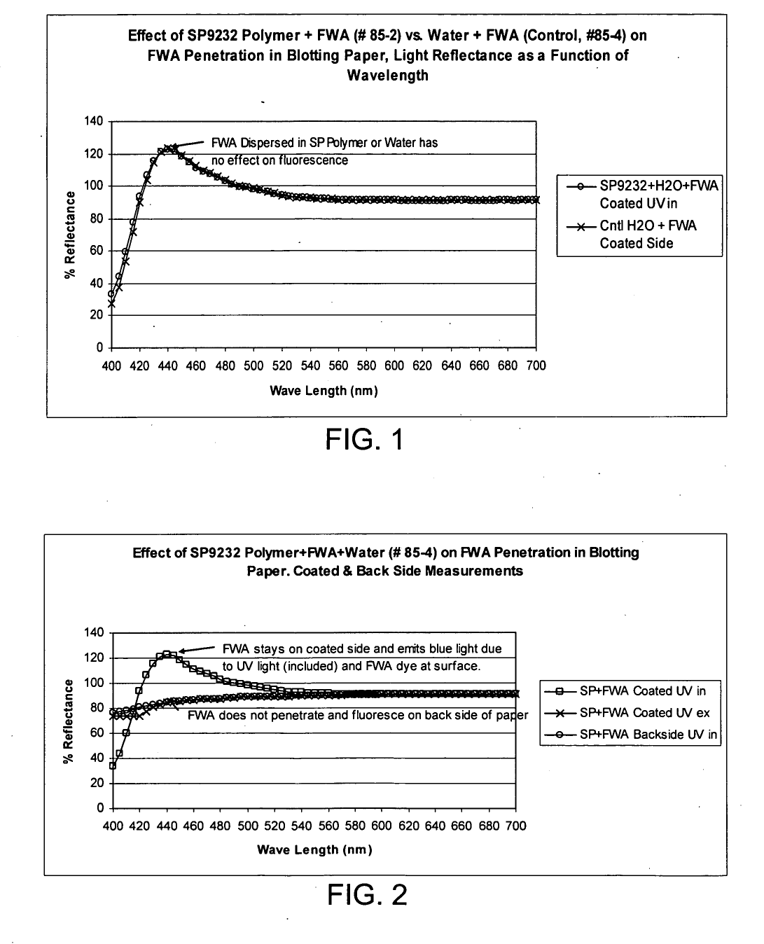

FIG. 1 shows that micropolymer (SP9232)+FWA+Water had comparable % blue light reflectance to that of FWA+Water alone. Paper surfaces were measured using a Technidyne Color Touch PC isobrightness meter using a 100 observer angle, D65 light source.

FIG. 2 shows the effect of SP9232 on FWA blue light reflectance on the coated side and uncoated back side of the blotting paper. As can be seen, the combination of micropolymer SP9232 and FWA (sample 85-4) preferentially stayed on the coated surface, as indicated by strong blue reflectance on the coated side when exposed to UV light. In contrast, no blue light reflectance was present on the back side when exposed to UV light (UV in) or when the UV light was filtered out (UV-ex). Thus, little FWA dye penetrated the paper as the water soaked to the back side upon application of the SP9232/FWA combination.

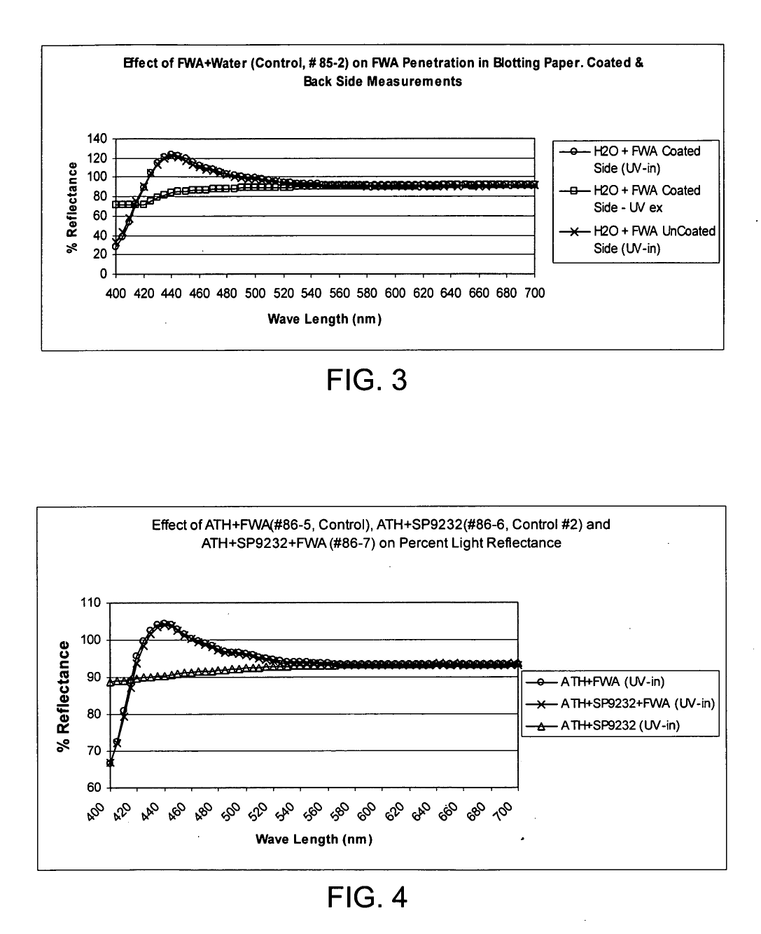

FIG. 3 shows the effect of FWA+water control sample (sample 85-2) blue light reflectance on the coated side and uncoated back side of the blotting paper. FWA dye penetrated the paper as the water soaked to the back side, as evidenced by the light reflectance peak on both sides. A large and similar reflectance peak in the 420-460 nm region illustrates that FWA is present on both the coated and uncoated side. In the presence of UV light (UV-in), the percent light reflectance data near 457 nm overlaps for both the coated and uncoated side (O and X data points overlap). When UV light exposure is excluded (UV-ex), the percent light reflectance as a function of wavelength for both the coated and uncoated side decreases in the 420 to 460 nm wavelength region. (Note: The FWA coated and uncoated side have the same percent reflectance curves when UV-light is excluded, so only one set of data is illustrated for the UV-ex spectrum in FIG. 3.)

### Example 2

### Combination of FWA, Micropolymer, and ATH

Table 2 shows the quantities for blending Almatis, 0.25 um alumina trihydrate (ATH) into the SP9232 and FWA. Mixtures of ATH and 0.1 wt % SP9232 result in a paste-like mixture. However, premixing the FWA into the SP9232 provided better compatibility with dry ATH powder without a significant slurry viscosity increase. All amounts of ingredients are in grams.

TABLE 2

| | | | | SP9232 + |
|---|---|---|---|---|
| | | FWA + | SP9232 + | FWA + |
| | Tradename, | ATH (2) | ATH (1, 4) | ATH (3, 5) |
| Reagent | if applicable | 86-5 | 86-6 | 86-7 |
| SP9232 | PERFORM | — | 5 | 5 |
| (0.1 wt. % ) | SP9232 | | | |
| FWA | TINOPAL AB-P | 0.06 | 0 | 0.06 |
| Deionized | | 5 | 0 | 0 |
| Water | | | | |
| ATH | SPACERITE | 3.84 | 3.84 | 3.84 |
| | S-11 | | | |

Observations on treated paper
(1) No fluorescence
(2) Water sinks through to opposite side, carrying FWA
(3) FWA stays on top
(4) Flocculates ATH, paste-like coating
(5) Adding FWA to the SP9232 significantly reduces viscosity.

The pigment slurries in Table 2 were drawn down on blotting paper in a manner similar to that of Example 1.

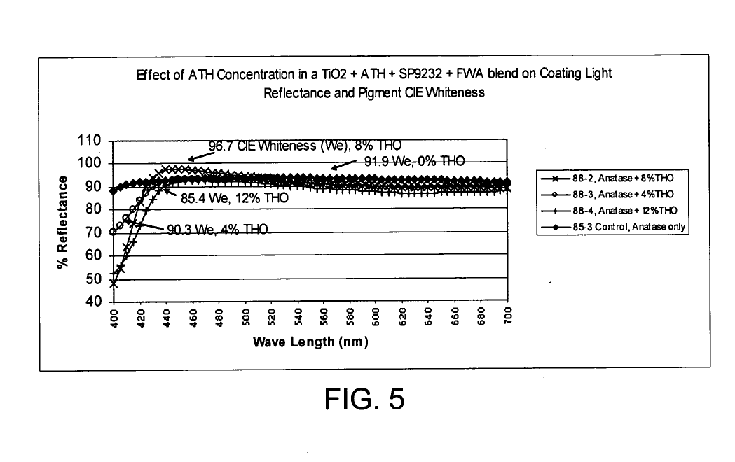

FIG. 4 shows that FWA fluoresced a blue reflectance in the presence of either ATH (#86-5) or the ATH/SP9232 blend (#86-7). The ATH/SP9232 control (#86-6) contained no FWA, thus the reflectance peak remains relatively flat across the light reflectance spectrum. All pigment coating samples were subjected to a D65 light source with the UV light component included (UV-in).

### Example 3

### FWA, Micropolymer, and ATH Slurry(“THO slurry”), and Combinations With TiO₂

Table 3 shows the composition for a pre-blended formulation called “THO slurry” that incorporates SP9232, FWA and ATH in the amounts listed. The final THO slurry was weighed “as-is” at approximately, 4, 8 and 12 wt. % solids based on TiO₂ (dry on dry basis) and drawn as a coating on a glass plate using a 8 mil Byrd applicator. (Note: A glass plate does not absorb the water while the pigment coating is drying, thus making it possible to measure the composite pigment color.) The dried coating was rubbed gently with the index finger to eliminate surface glossiness, which would interfere with brightness and whiteness measurements, which were subsequently performed using a Technidyne Color Touch PC Isobrightness meter. All amounts of ingredients are in grams.

TABLE 3

| | | Wt. % THO on | | | |
|---|---|---|---|---|---|
| | | TiO₂ | | | (Control) |
| | | 8% | 4% | 12% | Anatase |
| | Tradename, | THO | THO | THO | Only(1) |
| Reagent | if applicable | 88-2 | 88-3 | 88-4 | 85-3 |
| SP9232 | PERFORM | 5 | 5 | 5 | 0 |
| (0.1 wt. %) | SP9232 | | | | |
| FWA | TINOPAL AB-P | 0.06 | 0.06 | 0.06 | 0 |
| Deionized Water | | — | — | — | 0 |
| ATH | SPACERITE S-11 | 3.84 | 3.84 | 3.84 | 0 |
| SP9232 + | THO Slurry | 0.92 | 0.46 | 1.38 | 0 |
| FWA + ATH | | | | | |
| (43 wt %) | | | | | |
| TiO₂ (70.0 wt %) | A-25 Slurry | 7.14 | 7.14 | 7.14 | 7.14 |

(1) No fluorescence of pigment coating on glass plates

FIG. 5 shows that at a constant ratio of FWA/SP9232 to ATH there are favorable concentrations, namely about 8 wt. % based on TiO₂, that provided optimum TiO₂ pigment CIE whiteness out of all the formulations of Table 3. At 8 wt. % THO, CIE whiteness was 96.7 versus the control anatase slurry at 91.9 containing no THO slurry. Adding too much of the THO slurry (12 wt % based on TiO₂, dry on dry basis) decreased CIE whiteness to 85.4. Also adding too little THO slurry (4 wt. % based on TiO₂, dry on dry basis) decreased CIE whiteness to 90.3.

At high THO concentrations the decrease in CIE whiteness is believed to be due to the high concentration of the FWA. The final paper coating whiteness was. influenced by how much the TiO₂/THO blend was diluted. The plots shown in FIG. 5 demonstrate that pigment whiteness can be improved by careful selection of FWA and ATH. Without wishing to be bound by any particular theory or explanation, it is believed that the SP9232 acts as a mordant to retain FWA at the surface of paper and prevent FWA migration. The SP9232 may also loosely adhere the TiO₂ to the ATH. In any case, the result is surprisingly good rheology in the pigment slurry and coating slurry.

### Example 4

### Concentrated FWA, Micropolymer, and ATH Slurry(“THO Master Batch 81-a”), and Combinations with TiO₂

Table 4 shows the composition for a concentrated pre-blended formulation called “THO master batch 81-a” that incorporates SP9232, FWA and ATH in the amounts listed. Approximately 70 grams of the THO master batch 81-a was added after the TiO₂ grind solids achieved 83+% solids. The high solids TiO₂ slurry did not set up (i.e., did not become solid or of extremely high viscosity) with the addition of the micropolymer THO complex during the dilution step. The amounts of ingredients used in example 4 are in grams.

TABLE 4

| | | | Master | TiO₂ |
|---|---|---|---|---|
| | | Tradename, | Batch | Grind |
| Reagent | | if applicable | 81-a | 81-b |
| 1. | Deionized Water | | 296 | |
| s2. | SP9232 (1.0 wt. %) | PERFORM SP9232 | 3.4 | |
| 3. | FWA | TINOPAL AB-P | 4 | |
| 4. | ATH | SPACERITE S-11 | 209.6 | |
| 5. | 34 g DI Water + | | 34.6 | |
| | 0.6 g Citric Acid | | | |
| 1. | Deionized Water | | | 160 |
| 2. | Aminomethyl propanol | AMP-95 | | 2 |
| 3. | TiO₂* | A-25 | | 819 |
| 4. | SP9232 + FWA + | THO Slurry 81-a | | 69.87 |
| | ATH (43 wt %) | | | |

*After adding TiO₂ slurry grind solids is 82.4 wt %, Add THO 81-a quickly. Final 81-b solids = 73.4 wt. %

### Example 5

### Wet-End Addition of A-2600 vs. THO in Handsheets

TiO₂ was added so that 40 lbs TiO₂/ton OD pulp was retained in the sheet. The pulp consisted of a blend of 50% Hardwood, 30% Softwood, and 20% BCTMP at 8 pH. Handsheet basis weight was 55 lb/3300 ft².

Table 5 shows the order of addition for cationic starch and filler pigment followed by TiO₂ and a cationic polyacrylamide (0.5 lb/ton) followed by PERFORM SP9232 (0.5 lb/ton) used as a retention aid (2 lbs/ton).

TABLE 5

| | | | Wt % on |
|---|---|---|---|
| Order of addition | % solids | | Dry pulp |
| | | Amt. | |
| | | Added | |
| | | (lb/ton) | |
| 1. Pulp Stock added | 0.257 | | |
| 2. STA-LOK 300A | 37.08 | 10 | 0.5 |
| starch | | | |
| 3. PCC¹ | 21.91 | 130 | 6.5 |
| 4. GCC² | 60.81 | 200 | 10 |
| | | Amount | |
| | | in sheet | |
| | | (lb/ton) | |
| 5. RPS-VANTAGE TiO₂ | 71.5 | 40 | 2 |
| 5. T4000 TiO₂ | 77.16 | 40 | 2 |
| 5. A-2600 TiO₂ | 70.29 | 40 | 2 |
| 5. A-2600/THO | 71.06 | 40 | 2 |
| | | Amt. | |
| | | Added | |
| | | (lb/ton) | |
| 6. PERCOL 3320³ | 0.03 | 0.5 | 0.025 |
| 7. PERFORM SP9232 | 0.12 | 2 | 0.1 |

¹Staley Ground Calcium Carbonate
²Ground Calcium Carbonate
³Cationic polyacrylamide

Table 6 shows the results obtained for the handsheets described in Table 5. As can be seen, the highest first pass ash retention, highest D65 IsoBrightness, highest Tappi Brightness and Opacity were achieved using A-2600 with 8wt % ATH (as THO) from grind 81-b. Commercial rutile slurry (RPS-VANTAGE™, DuPont) and anatase slurry (T-4000, Millennium) had poorer optics and retention. A 50/50 blend of RPS-VANTAGE™ rutile with A-2600/THO improved the rutile slurry performance in paper by increasing brightness and opacity vs. RPS-VANTAGE™ (RPS-V) alone.

TABLE 6

| | | | | A-2600/ | 50% RPS-V/ |
|---|---|---|---|---|---|
| | RPS-V | T-4000 | A-2600 | TH0 | 50% A-2600/THO |
| % First Pass | 35 | 45 | 74 | 73 | 55 |
| Ash | | | | | |
| D65 Iso | 80.2 | 80.2 | 80.4 | 81.0 | 81.2 |
| Brightness | | | | | |
| Tappi | 79.4 | 79.4 | 80.3 | 80.4 | 80.3 |
| Brightness | | | | | |
| Opacity | 87.8 | 87.7 | 88.0 | 88.7 | 88.8 |

### Example 6

### Coating Example

TiO₂ was added at 7 parts in a 60/40 Clay/GCC coating formulation. SBR binder was 12 parts and the FWA was varied at 0, 1.5 and 3 parts in the coating. Base sheet at 32 lb/3300ft² was coated using a web offset formulation so that 6 lb/3300ft² was coated uniformly on one side. The coating was applied by a CLC 6000 at short dwell blade coater at 6000 feet/min and dried by infrared lights. The coated paper was calendered in a soft nip heated calender at 2250 pli at 190° F.

Table 7 shows the opacity and CIE whiteness of anatase TiO₂ enhanced with THO versus a higher refractive index rutile TiO₂ without THO. Optics were determined using a Technidyne S5 with a 10° observer angle, using a C2 light source. The CIE whiteness provided by A-2600/THO was consistently approximately 1-2 points higher than the rutile commercial slurry control over all FWA ranges, except at the 0 parts FWA condition with calendaring. A-2600/THO opacity was approximately 0.6-2 points higher in uncalendered paper over all FWA dosages versus 0.2-1 point higher opacity after calendering.

TABLE 7

| | | CIE Whiteness, % | CIE Whiteness, % | Opacity, % | Opacity, % |
|---|---|---|---|---|---|
| | Parts | Uncalendered | Calendered | Uncalendered | Calendered |
| Samples ID | FWA | Average | Average | Average | Average |
| A-2600/THO | 0 | 82.8 | 78.9 | 82.8 | 84.5 |
| RPS- | 0 | 81.6 | 79.0 | 81.6 | 83.7 |
| VANTAGE ™ | | | | | |
| A-2600/THO | 1.5 | 86.5 | 84.2 | 86.5 | 84.0 |
| RPS- | 1.5 | 84.5 | 81.8 | 84.5 | 83.5 |
| VANTAGE ™ | | | | | |
| A-2600/THO | 3 | 85.1 | 83.0 | 85.1 | 84.4 |
| RPS- | 3 | 83.3 | 81.8 | 83.3 | 84.2 |
| VANTAGE ™ | | | | | |

Compositions according to the invention are very useful in making paper, where they can be added to the pulp slurry according to methods well known in the papermaking art, or applied to a sheet in a coating formulation, resulting in paper having good brightness and opacity. The compositions of this invention may also be sprayed or otherwise applied to paper or other substrates, especially those substrates having anionic surface charge.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. A composition comprising an fluorescent whitening agent and a micropolymer.

2. The composition of claim 1, wherein the micropolymer comprises a structured organic particulate.

3. The composition of claim 1, wherein the micropolymer comprises a water soluble, anionically charged three-dimensional micro-complex.

4. The composition of claim 1, wherein the micropolymer comprises an anionic drainage/retention/formation aid anionic organic polymer or anionic microparticulate.

5. The composition of claim 1, wherein the micropolymer comprises an anionic polymer having a Huggins' constant (k′) as determined in 0.01M NaCl of greater than 0.75 and a storage modulus (G′) for a 1.5 wt. % actives polymer solution at 4.6 Hz of greater than 175 Pa;
wherein the anionic copolymer is of the formula: [symbol]
B-co-F [symbol] (Formula I)
wherein B is a nonionic polymer segment formed from the polymerization of one or more nonionic monomers; F is an anionic polymer segment formed from polymerization of one or more ethylenically unsaturated anionic monomers; and the molar % ratio B:F is from 5:95 to 95:5.

6. The composition of claim 1, wherein at least a portion of the fluorescent whitening agent and at least a portion of the micropolymer are bound together.

7. The composition of claim 1, wherein the composition is aqueous, and wherein the fluorescent whitening agent and the micropolymer together constitute at least 10 wt % of all nonvolatile organic components in the composition.

8. The composition of claim 1, wherein the composition is aqueous, and wherein the fluorescent whitening agent and the micropolymer together comprise at least 0.01 wt % of the composition.

9. The composition of claim 1, further comprising an inorganic filler.

10. The composition of claim 9, wherein the filler comprises alumina trihydrate.

11. The composition of claim 10, further comprising citric acid.

12. The composition of claim 10, wherein at least a portion of the alumina trihydrate and at least a portion of the micropolymer are bound together.

13. The composition of claim 12, wherein at least a portion of the fluorescent whitening agent and at least a portion of the micropolymer are bound together.

14. The composition of claim 10, wherein at least a portion of the composition consists of composite particles each comprising the micropolymer, the fluorescent whitening agent, and the alumina trihydrate.

15. The composition of claim 10, further comprising titanium dioxide.

16. The composition of claim 15, wherein the titanium dioxide comprises anatase.

17. The composition of claim 16, wherein the titanium dioxide further comprises rutile.

18. In a paper coating, the improvement comprising including in the coating a composition comprising an fluorescent whitening agent and a micropolymer.

19. The paper coating of claim 18, wherein the micropolymer comprises an anionic polymer having a Huggins' constant (k′) as determined in 0.01M NaCl of greater than 0.75 and a storage modulus (G′) for a 1.5 wt. % actives polymer solution at 4.6 Hz of greater than 175 Pa;
wherein the anionic copolymer is of the formula: [symbol]
B-co-F [symbol] (Formula I)
wherein B is a nonionic polymer segment formed from the polymerization of one or more nonionic monomers; F is an anionic polymer segment formed from polymerization of one or more ethylenically unsaturated anionic monomers; and the molar % ratio B:F is from 5:95 to 95:5.

20. A method of treating paper, the method comprising applying to the paper a composition comprising an fluorescent whitening agent and a micropolymer.

21. The method of claim 20, wherein the micropolymer comprises an anionic polymer having a Huggins' constant (k′) as determined in 0.01M NaCl of greater than 0.75 and a storage modulus (G′) for a 1.5 wt. % actives polymer solution at 4.6 Hz of greater than 175 Pa;
wherein the anionic copolymer is of the formula: [symbol]
B-co-F [symbol] (Formula I)
wherein B is a nonionic polymer segment formed from the polymerization of one or more nonionic monomers; F is an anionic polymer segment formed from polymerization of one or more ethylenically unsaturated anionic monomers; and the molar % ratio B:F is from 5:95 to 95:5.

22. A method of making paper, the method comprising adding to a pulp slurry a composition comprising an fluorescent whitening agent and a micropolymer.

23. The method of claim 22, wherein the micropolymer comprises an anionic polymer having a Huggins' constant (k′) as determined in 0.01M NaCl of greater than 0.75 and a storage modulus (G′) for a 1.5 wt. % actives polymer solution at 4.6 Hz of greater than 175 Pa;
wherein the anionic copolymer is of the formula: [symbol]
B-co-F [symbol] (Formula I)
wherein B is a nonionic polymer segment formed from the polymerization of one or more nonionic monomers; F is an anionic polymer segment formed from polymerization of one or more ethylenically unsaturated anionic monomers; and the molar % ratio B:F is from 5:95 to 95:5.
